(19) United States
(12) Patent Application Publication
(10) Pub. No.: US 2007/0174125 A1
(43) Pub. Date: Jul. 26, 2007

(54) Targeted ad insertion

(75) Inventors: Andrew J.B. Poole, Louisville, CO (US); Joseph R. Matarese, Portland, OR (US)

Correspondence Address: FSP LLC, P.O. BOX 890, VANCOUVER, WA, 98666, US

(73) Assignee: Broadband Royalty Corporation, Wilmington, DE (US)

(21) Appl. No.: 11/698,266

(22) Filed: Jan. 25, 2007

Related U.S. Application Data
(60) Provisional application No. 60/762,451, filed on Jan. 25, 2006.

(51) Int. Cl. G06Q 30/00; H04N 7/10

(52) U.S. Cl. 705/14; 725/32

(57) ABSTRACT

In response to one or more ad break indications, one or more channel changes may be caused from a program stream channel to one or more other channels comprising advertising content.

### PRIORITY CLAIM

The present application claims priority as a utility patent application corresponding to subject matter of United States provisional patent application TARGETED AD INSERTION, having application No. 60/762,451, filed on Wednesday, Jan. 25, 2006, which is incorporated herein by reference in its entirety.

### TECHNICAL FIELD

The present disclosure relates to advertising insertion/association with programming/on demand content delivered over a network.

### BACKGROUND

Traditional approaches to advertising insertion have focused on replacing defined portions of program content streams with advertising content. Advertising content is typically inserted within the network infrastructure, for example using stream splicing equipment or at the head end systems from which the content is streamed.

These traditional approaches to advertising insertion are complex and somewhat difficult to scale up. More flexible approaches to advertising insertion are needed in order to provide greater control and flexibility to system implementations.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A method may include and/or involve, in response to one or more ad break indications, causing one or more channel changes from a program stream channel to one or more other channels including advertising content. Causing one or more channel changes from a program stream channel to one or more other channels comprising advertising content may include and/or involve causing the one or more channel changes in response to ad break indications comprised by the program stream, and/or causing the one or more channel changes in response to ad break information provided separately from the program stream, and/or causing one or more channel changes to embedded advertising in program streams on one or more other channels, and/or causing changes to one or more channels within a group of multiple channels which are predominately composed of advertising content.

Causing the one or more channel changes in response to ad break information provided separately from the program stream may include and/or involve causing the one or more channel changes in response to ad break information provided via one or more Internet-type interfaces, and/or causing the one or more channel changes in response to ad break information provided in one or more QAM channels different from the program stream channel. Causing changes to one or more channels within a group of multiple channels which are predominately composed of advertising content may include and/or involve causing changes to one or more channels including one or more ad pools targeted to one or more subscriber characteristics. Causing the one or more channel changes in response to ad break information provided via one or more Internet-type interfaces may include and/or involve causing the one or more channel changes in response to ad break information provided via one or more TCP/IP interfaces.

Causing changes to one or more channels comprising one or more ad pools targeted to one or more subscriber characteristics may include and/or involve causing changes to one or more ad pools targeted to characteristics of one or more subscribers associated with equipment receiving the program stream channel, and/or network equipment selecting one or more ads of the ad pools that should be presented to the subscriber, and communicating channel information to the equipment for the one or more selected ads. Causing changes to one or more ad pools targeted to characteristics of one or more subscribers associated with the equipment receiving the program stream channel may include and/or involve causing changes to one or more ad pools targeted to one or more of subscription information, content viewing habits of the subscribers, characteristic of an area and/or region including subscriber premises, subscriber demographic information, subscriber financial and/or income and/or employment information, or subscriber Internet viewing habits.

The method may include and/or involve forming ad pools for a subscriber region at least in part according to characteristics of the region and/or subscribers therein.

The method may include and/or involve embedding ad content of the ad pools in multiple program streams.

The method may include and/or involve the subscriber equipment selecting which ad content to render from among multiple available ads on the other channels including advertising content.

The method may include and/or involve causing one or more channel changes back to the program stream at the conclusion of one or more ad break durations.

The method may include and/or involve the program stream including identifications of the one or more other channels including advertising content.

The method may include and/or involve introducing one or more delays between the program content stream and one or more streams including the advertising content. Introducing one or more delays between the program content stream and one or more streams comprising the advertising content may include and/or involve the equipment buffering at least a portion of the advertising content, and/or the equipment buffering at least a portion of the program content.

The method may include and/or involve communicating ad break information for the program stream to one or more terminal devices prior to, at, or near to a time or times when the program stream is delivered to the terminal devices.

The method may include and/or involve communicating ad break information for the program stream to one or more terminal devices prior to, at, or near to a time or times when the advertising content is to be presented to one or more users of the terminal devices.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits in a reference number refer to the figure number in which that element is first introduced.

FIG. 1 is a block diagram of an embodiment of a media distribution and advertising system.

FIG. 2 is a block diagram of an embodiment of a cable television media distribution and advertising system.

FIG. 3 is a time line diagram of an embodiment of advertising and programming content delivery.

FIG. 4 is a time line diagram of an embodiment of advertising and programming content delivery involving buffering of advertising content.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or fimmware.

References to “advertising insertion” herein do not necessarily indicate the physical insertion of advertising content into the same stream with programming content. Rather, new flexible approaches described herein as “advertising insertion” may in fact involve channel changes to content in different frequency bands; from the viewer's point of view the advertising is inserted into the programming that they are viewing; in fact the programming stream may not be altered in every case.

Actions described herein may be implemented by subscriber premise equipment, and, or alternatively, by regional distribution equipment such as edge QAMs and/or splicers. The term “render” may refer to the playing of audio and/or visual information at a subscriber location, and/or to the transmission of input audio and/or visual information to outputs of regional equipment. For example, regional equipment such as edge QAMs/splicers may render audio/visual information by directing the audio/visual information to one or more outputs to subscriber premises.

Media Distribution and Advertising System

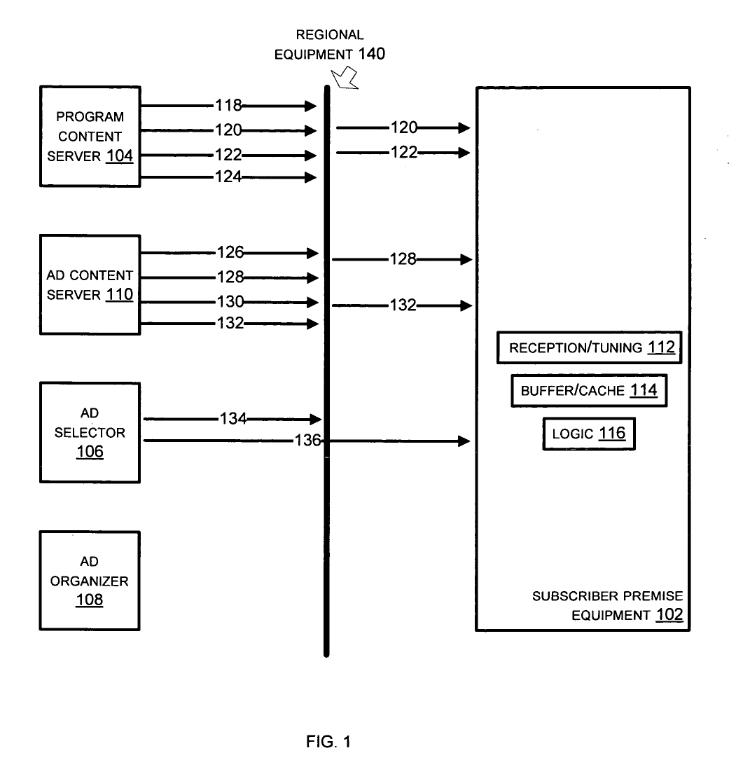

FIG. 1 is a block diagram of an embodiment of a media distribution and advertising system. One or more video servers 104 generate multiple streams 118, 120, 122, and 124 of programming content. One or more ad servers 110 generate multiple streams of ad content 126, 128, 130, 132. In many implementations, the video server 104 may also serve the ad content 126 128 130 132, although this need not be the case.

A stream may comprise of one or more ads, which have been organized into one or more ad pools. An ad pool is a grouping of one or more ads having a common characteristic or characteristics. A few examples of such common characteristics follow. Ads in an ad pool may be targeted to consumers of a certain income or asset range. For example, ads for banking, insurance or brokerage services may target consumers which are considered to have at least the median income. Ads in an ad pool may be targeted to consumers of a certain age range and/or gender. For example, retired seniors may be targeted by ads for RVs, for vacation cruises, or for Medicaid supplement insurance. High school and college students may be targeted by one or more ad pools promoting items such as laptop computers, music players, or first cars. Ads in an ad pool may be targeted to consumers having a certain sexual orientation or family characteristic. For example, consumers having children between six and eighteen may be targeted with ads for fast food restaurants.

One or more ad organizers 108 may comprise logic to determine the content of ad pools by applying various metadata pertaining to ad characteristics, ad schedules, and/or programming characteristics, among other things. The contents of ad pools may vary over time and/or according to past and/or present viewing conditions.

One or more ad selectors 106 may comprise logic to choose which ads to deliver to one or more subscribers and/or to one or more grouping of subscribers. An ad selector 106 may comprise logic to select individual ads and/or ad pools to deliver to subscriber equipment 102. Ads may be delivered in various ways. For example, ads may be delivered embedded in program content. Ads may also or alternatively be delivered as content on one or more separate channels from the program content with which they are associated.

The programming server 104, ad server 110, ad selector 106, and ad organizer 108 may be implemented using distinct devices, or may be logic within an integrated video server device, such as a multi-node hypercube media server. Those skilled in the art will appreciate that functions of the programming server 104, ad server 110, ad selector 106, and ad organizer 108 may also be arranged in various fashions among one or several devices, which may or may not be located proximate with one another. Also, a particular implementation of a media delivery system may include several instances of one or more of these device types.

The program video server 104 and/or the ad server 110 may package content streams into one or several MPEG single or multiple program transport streams, using for example one or more of the MPEG2, MPEG3, or MPEG4 protocols. Programming content may comprise ad break indicators. In some embodiments, the ad break indicators may remain in the streams as they move through the distribution network. In some embodiments, some or all of the ad break indicators may be removed from the programming streams, and ad content may be spliced into the programming streams at ad break locations.

One or more of the various components of the head end may communicate control information 134 to area and/or regional equipment 140, such as splicers and/or QAMs. Regional equipment may also comprise switches and/or other networking equipment. Control information 136 may also be communicated to subscriber equipment 102. Regional equipment may operate to pass some but not necessarily all of the programming and/or advertising streams from the head end(s) to subscriber equipment 102. For example, in switched broadcast networks only streams that have been requested (for example, through tuning requests and/or through video-on-demand requests) may be provided by the regional equipment to the subscriber equipment in the region.

Subscriber equipment 102 and/or regional equipment 140 may comprise reception, tuning, and rendering logic 112. The logic 112 may operate to receive digital and/or analog information from regional equipment, to tune to channels comprising programming and/or ad content, and/or to render programming and/or ad content to viewers. Subscriber equipment 102 and/or regional equipment 140 may comprise content buffering and/or caching logic 114, which may operate to buffer/cache programming and/or advertising content. Buffering and/or caching may be implemented using memory such as caches and/or flash, the main program memory of the device, and/or using mass storage such as magnetic and/or optical disks. The subscriber equipment 102 and/or regional equipment 140 may comprise logic 116 to facilitate various functions described herein, such as processing control information from head ends and/or regional equipment, and/or other functions understood to be present by those skilled in the art.

Ad Break Indications and Ad Break Information

As a result of one or more ad break indications, one or more channel changes may be initiated (e.g. caused to happen) from a program stream channel to one or more other channels including advertising content (e.g. channel changes to render ad content). Ad break indications comprise information indicating that at a particular time and/or location relative to a present time and/or location, and/or at an absolute point in time and/or location, one or more ad breaks are present in a program content stream.

Ad break indications may in some embodiments comprise information about ad break duration and/or other information about one or more ad breaks. An ad break, as previously indicated, comprises one or more locations within a program content stream where one or more ads may be rendered.

Ad break indications and possibly additional ad break information may be provided within the content stream (e.g. as SCTE-35 queue packets), or may be provided separately from one or more ad break indications.

Channel changes to render ad content may include and/or involve causing the one or more channel changes in response to ad break indications comprised by the program stream, and/or may include and/or involve causing the one or more channel changes in response to ad break information provided separately from the program stream. The one or more channel changes may be caused in response to ad break information provided via one or more “data” type interfaces, e.g. information not formatted as a tunable program channel. One example of data interface include Internet-type interfaces, such as via one or more TCP/IP interfaces.

The one or more channel changes may be caused in response to ad break information provided in one or more QAM channels different from the program stream channel. At the subscriber equipment 102 and/or regional equipment 140, these channels may be tunable QAM channels having an assigned band in the QAM frequency range and assigned channel numbers.

A program stream may include identifications of the one or more ad content channels. Such identifications may be provided separately from ad break indications or may be delivered as a part of or in conjunction with it. Identifications of one or more ad channels delivered to the subscriber equipment 102 and/or regional equipment 140 may also be provided with or separately from the program stream.

Ad break information for the program stream may be communicated to one or more terminal devices (e.g. equipment 102 such as set top boxes) and/or regional equipment 140 prior to, at, or near to a time or times when the program stream is delivered to the terminal devices.

For example, ad break information and/or ad break indications may be delivered prior to delivering the programming content. The set top box 102 and/or regional equipment 140 may store the information/indications and apply them at the appropriate time. Ad content channel information delivered to subscriber equipment 102 and/or regional equipment 140 at a particular time in the content stream, for example at the start of a show. Ad content channel information may be delivered as a part of a program content stream or as a separate communication. Later, the subscriber equipment 102 and/or regional equipment 140 may receive one or more ad break indications within the program stream. The subscriber equipment 102 and/or regional equipment 140 may then, at the right moment, tune to the one or more ad content channels and render ad content comprised by the ad content channels. In some situations, the subscriber equipment 102 and/or regional equipment 140 may tune to one or more ad channels and buffer ad content comprised thereon. Later, at one or more ad breaks in program content, the subscriber equipment 102 and/or regional equipment 140 may render some or all of the buffered ad content.

In some embodiments, ad break information for a program stream may be communicated to one or more terminal devices prior to, at, or near to a time or times when the advertising content is to be presented to (e.g. rendered to) one or more users of the terminal devices.

Tuning Ad Content in Other Channels

Channel changes to render ad content may include and/or involve causing one or more channel changes to embedded advertising in program streams on one or more other channels. Some or all of the ads in an ad pool for a region may be distributed among the ad breaks in the program streams passed to the region. A particular device may be provided with ad break information indicating which channels comprise advertising content to use with the ad break.

Ad content may be obtained from one or more program content streams that are different from the program content stream currently being rendered by subscriber equipment. In some situations, ad content may be buffered to better synchronize the rendering of the ad content with one or more ad breaks.

Ad break information may indicate that one or more particular ads should be rendered at one or more particular ad break locations for one or more particular subscribers. Equipment may tune to one or more channels comprising the ad content at the appropriate ad break time(s). Some or all of the ad content may be buffered in order to ensure that the ad content is available when the ad break(s) occur in the program content. Buffering may be accomplished by the equipment tuning to the ad content channels at the appropriate time prior to the ad break(s) in order to receive and store the ad content. Equipment may continue to tune and render program content while the buffering of ad content takes place.

Information about which ad channels to tune and the time at which to tune those ad channels may be provided as part of a program content stream, or separately as for example in manners described herein.

Depending upon the implementation, there may be a single or multiple channels that comprise only advertising content. In other situations, the advertising content for a region may be provided as advertising embedded in multiple program streams being delivered to that region. Ad content may be targeted to specific subscribers and/or groups of subscribers.

For example, one ad channel may target older adolescents and single people. A second channel may target families with children at home. A third channel may target mature families and singles where any children are grown and one or more members is approaching or is retired. A fourth channel may target affluent individuals and families. Each channel may deliver ads from one or several ad pools. The channel targeting families with children at home may comprise an ad pool focused on major appliances (TVs, refrigerators, freezers, etc.), an ad pool focused on vehicles (minivans, SUVs, small sedans as second vehicles), an ad pool focused on games and recreation equipment (tents, soccer sets, educational games), and so on. An ad pool for vehicles targeting single people may comprise ads for inexpensive “first new cars”. Some ads may be present in more than one ad pool. For example, an ad focusing on a small sedan which may be used as a second family car or as a first new car may be present in an ad pool designated for the singles ad channel and in an ad pool designated for the family ad channel.

A particular ad pool may be provided on more than one ad channel. The system may in some cases provide parts of an ad pool on one or more channels, and other parts (with possibly some overlap) on one or more other channels.

Channel changes may be made to one or more channels including one or more ad pools targeted to one or more subscriber characteristics, such as ad pools targeted to characteristics of one or more subscribers associated with the equipment receiving the program stream channel, and/or ad pools targeted to one or more of subscription information, content viewing habits of the subscribers, characteristic of an area and/or region including subscriber premises, subscriber demographic information, subscriber financial and/or income and/or employment information, or subscriber Internet viewing habits.

Ad Selection and Pooling

Ad selection for regions and/or individual subscribers may occur at a central site or head end. In some situations, network equipment downstream from the head end (e.g. splicers, modulators, regional switches, etc.) may provide and/or participate in ad selection for one or more regions and/or subscribers. Thus, selection of ads may be accomplished by one or more of head end equipment, network equipment, and/or subscriber equipment.

Synchronizing Ad Content with Ad Breaks

One or more delays may be introduced between the program content stream and one or more streams including the advertising content in order to facilitate synchronization of ad content with ad breaks. Head end systems, equipment, and/or regional equipment of the network may buffer at least a portion of the advertising content. Ads may be buffered in part or in their entirety. In addition, or alternatively, head end systems, regional equipment, and/or equipment may buffer at least a portion of the program content in order to better synchronize ad breaks in the program content with advertising content on other channels.

Cable Television Media Distribution and Advertising System

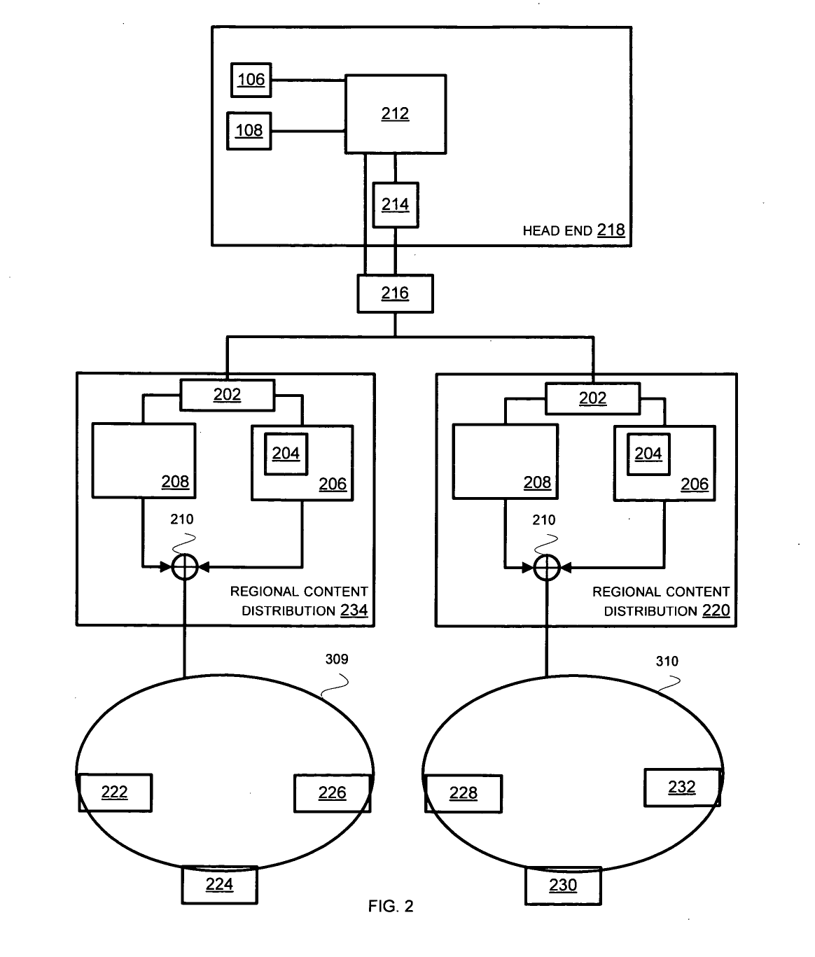

FIG. 2 is a block diagram of an embodiment of a cable television media distribution and advertising system. The cable system 2 includes a head end 218 comprising a data network 212, ad selector 106, and an ad organizer 108. The ad selector 106 selects ad content for streaming by one or more video servers 214. In FIG. 1, the ad server and program server functions were discussed as being either implemented in separate devices or within one device. FIG. 2 reflects an implementation where both program streaming and ad streaming functions are implemented within one video server 214 (which may in fact comprise multiple nodes of a media server hypercube). Of course, the ad organizer 108 and ad selector 106 functions may also be part of in a single device and/or system, and/or may share functionality with and/or be combined with one or more video servers.

The head end 218 of the cable television system may include and/or involve one or more communication interfaces to regional distribution nodes 234 and 220. Two regional nodes 234 and 220 and a single head end 218 are shown for purposes of discussion. In practice, the system may comprise multiple head ends and/or more or fewer regional nodes.

The head end 218 may include an interface to a high speed switch 216, such as a gigabit-class Ethernet switch. The head end 218 may employ the video server 214 to provide streamed content to the switch 216, and may also provide routing information to direct the content to the appropriate regional node(s). There may be other communications interfaces (not shown) between the system components, such as a communication interface between the switching network 212 of the head end 218 and the switch 216.

The regional distribution nodes 234 and 220 each serve content through a regional distribution plant to various endpoint devices 222, 224, 226, 228, 230, and 232 typically located on or near subscriber premises. To accomplish this, they may at times communicate information such as program/channel requests generated by subscriber equipment upstream to head end logic such as one or more session manager applications, which may service the program/channel requests.

Each region may include one or more splicers 202, which may combine ad content into the program content stream and may also remove ad insertion indications present within the programming stream. In some embodiments, the splicer may be directed to, either some or all of the time, keep the ad insertion indications in the content stream and/or also possibly not perform ad insertion. A digital output stream comprising program content with or without ads inserted therein may be delivered to both a digital modulator 208 (e.g. a QAM modulator), and to a digital to analog converter 204 for processing of the stream into an analog representation prior to analog modulation 206. In some situations, analog and digital representations of the stream may be aggregated 210 and communicated to endpoint devices such as a set top box or other subscriber premise equipment 222, 224, 226, 228, 230, and 232. Modern implementations may involve distribution of purely digital streams, without an analog component.

In some situations, at least some of the endpoint devices may comprise set-top boxes, ODAs, and/or VNIUs (video network interface units) providing digital to analog conversion and/or analog modulation at or near the subscriber premises. In such situations it may be possible to do without one or more of the network D/As 204, analog modulators 206, and/or combining network.

In some situations, program and/or ad streams may be aggregated as a digital multicast, prior to modulation in what is known to one skilled in the art as a combining network. Devices manipulating the digital stream within the region, such as the modulator 208 may receive a multicast comprising many programs, and may only pass to region(s) it serves those digital programs that are presently being tuned by endpoint devices in the region. When the system is embodied with one or multiple “ad only” channels or streams, the modulator 208 may only pass to region(s) 234 or 220 it serves those ad pools or ads which are destined for premise equipment 222, 224, 226, 228, 230, and 232 within those regions. Whether all of an ad pool is passed or particular ads are selected for passing may depend on control signals passing from devices such as the ad selector 106, video server 214, and/or session manager logic (not shown). In some embodiments, control signals coming from the premise equipment 222, 224, 226, 228, 230, and 232 may also be involved in advertising selection.

The regional equipment 234, 220 and/or premise equipment 222, 224, 226, 228, 230, and 232 may receive and communicate control information in various fashions. For example, control information may be received and/or communicated using and Internet-type protocol connection (e.g. TCP/IP, HTTP, etc). Control information may be received in some embodiments as QAM (quadrature amplitude modulated) information of a tunable “data channel”. In some cases, control information may be received as QAM information of one or more programming streams to which the equipment is tuned. Control information may identify one or more channels to which the equipment should tune in order to receive advertising information to go along with the programming content the equipment is currently tuned to and rendering. Control information may also include other identifying and timing information.

In some embodiments, equipment may completely or partially buffer ad and/or programming content in order to synchronize ad content with program content ad breaks. In some situations ad content may be provided using one or more “ad only” channels. In other situations ad content may be contained within one or more different channels of programming content, and equipment may be directed to tune the different channels of programming content during delivery of the ad content.

Advertising and Programming Content Delivery.

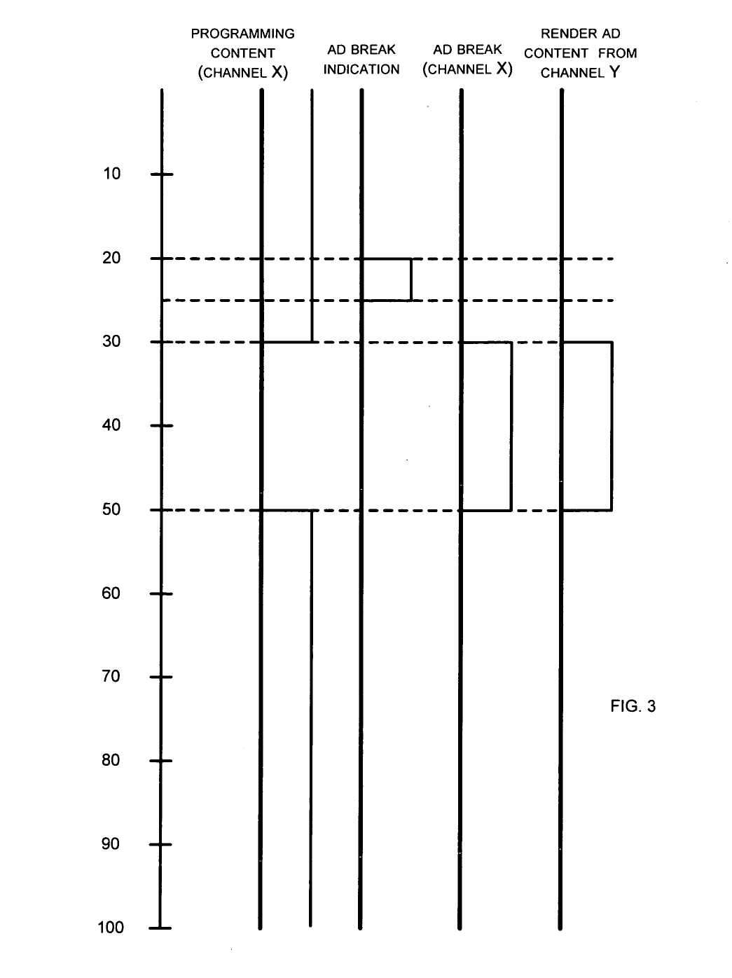

FIG. 3 is a time line diagram of an embodiment of advertising and programming content delivery. Initially the equipment is tuned to and rendering programming content on channel X. At 20, an ad break indication is received by the equipment. The ad break indication may be comprised by the programming content stream on channel X, or it may be delivered separately, for example using an Internet-type data interface or using a QAM data channel. In some situations, the ad break indication may be received earlier than time 20 (perhaps much earlier), and may be merely applied at time 20 and/or at time 30 when the ad break occurs. The ad break indication may indicate to the equipment the tunable channel or channels comprising the ad content, and may also indicate when one or more ad breaks will occur. The equipment continues to receive and play the programming content on channel X until time 30. The equipment tunes to channel Y at time 30 when the ad break occurs. From time 30 to time 50 the equipment tunes to channel Y to receive and render the ad content. Channel Y may be one (or more) tunable channels comprising exclusively advertising content, e.g. one or more ads in a single program transport stream. Channel Y may be one (or more) tunable channels comprising programming and advertising content, e.g. one or more single program transport streams comprising programming content with embedded advertising.

At time 50, the equipment tunes back to channel X and continues to receive and render the programming content. Thus, the equipment may cause one or more channel changes back to the program stream at the conclusion of one or more ad break durations.

Advertising and Programming Content Delivery with Buffering

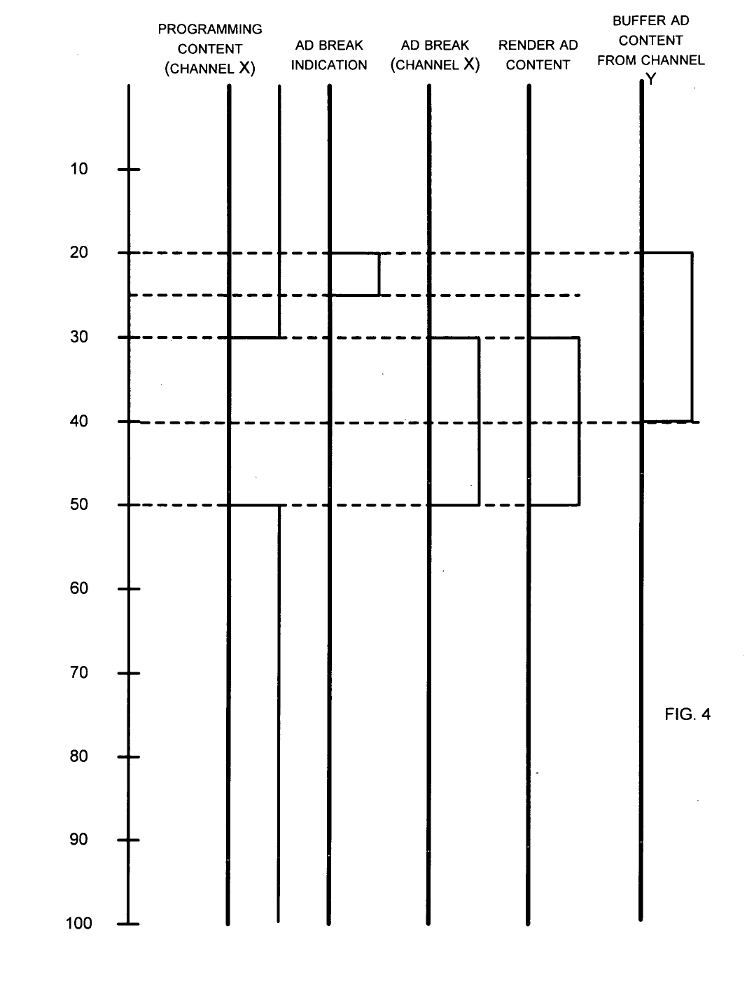

FIG. 4 is a time line diagram of an embodiment of advertising and programming content delivery involving buffering of advertising content.

Initially the equipment is tuned to and playing programming content on channel X. At 20, an ad break indication is received by the equipment. The ad break indication may be comprised by the programming content stream on channel X, or it may be delivered separately, for example using an Internet-type data interface or using a QAM data channel. In some situations, the ad break indication may be received earlier than time 20 (perhaps much earlier), and may be merely applied at time 20 and/or at time 30 when the ad break occurs. The ad break indication may indicate to the equipment the tunable channel or channels comprising the ad content, and may also indicate when one or more ad breaks will occur.

Also at 20, the equipment tunes to channel Y and begins buffering advertising content from channel Y. The equipment continues to receive and play the programming content on channel X until time 30. The equipment renders the advertising content buffered from channel Y at time 30 when the ad break occurs. Buffering of advertising content from channel Y ends at 40, however, the equipment continues to render the buffered advertising content until time 50.

Channel Y may be one (or more) tunable channels comprising exclusively advertising content, e.g. one or more ads in a single program transport stream. Channel Y may be one (or more) tunable channels comprising programming and advertising content, e.g. one or more single program transport streams comprising programming content with embedded advertising.

At time 50, the equipment tunes back to channel X and continues to receive and render the programming content.

FIG. 4 illustrates an example of buffering of one or more entire ads. However, in some embodiments the equipment may also or alternatively provide partial buffering. For example, if the ad content begins arriving at the equipment ten seconds before the ad break interval, the equipment may buffer ten seconds worth of the ad content. When the ad break interval begins, the equipment may begin to render the ad content from the ten second ad buffer. The equipment may then begin buffering the next ten second of advertising content in a circular fashion by overwriting the already-rendered advertising content.

Those having skill in the art will appreciate that there are various vehicles by which processes and/or systems described herein can be effected (e.g., hardware, software, and/or firmware), and that the preferred vehicle will vary with the context in which the processes are deployed. For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations may involve optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Several portions of the subject matter subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into larger systems. That is, at least a portion of the devices and/or processes described herein can be integrated into a network processing system via a reasonable amount of experimentation.

The foregoing described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

What is claimed is:

1. A method comprising:
in response to one or more ad break indications received by regional content distribution equipment, causing one or more channel changes from a program stream channel to one or more other channels comprising advertising content, so that the advertising content is rendered on the program stream channel output by the regional equipment without splicing of the advertising content into the program stream.

2. The method of claim 1, wherein the in response to one or more ad break indications, causing one or more channel changes from a program stream channel to one or more other channels comprising advertising content further comprises:
causing the one or more channel changes in response to ad break indications comprised by the program stream.

3. The method of claim 1, wherein the in response to one or more ad break indications, causing one or more channel changes from a program stream channel to one or more other channels comprising advertising content further comprises:
causing the one or more channel changes in response to ad break information provided separately from the program stream.

4. The method of claim 3, wherein the causing the one or more channel changes in response to ad break information provided separately from the program stream further comprises:
causing the one or more channel changes in response to ad break information provided via one or more Internet-type interfaces.

5. The method of claim 4, wherein causing the one or more channel changes in response to ad break information provided via one or more Internet-type interfaces further comprises:
causing the one or more channel changes in response to ad break information provided via one or more TCP/IP interfaces.

6. The method of claim 3, wherein the causing the one or more channel changes in response to ad break information provided separately from the program stream further comprises:
causing the one or more channel changes in response to ad break information provided in one or more QAM channels different from the program stream channel.

7. The method of claim 1, wherein the in response to one or more ad break indications, causing one or more channel changes from a program stream channel to one or more other channels comprising advertising content further comprises:
causing one or more channel changes to embedded advertising in program streams on one or more other channels.

8. The method of claim 1, wherein causing one or more channel changes from a program stream channel to one or more other channels comprising advertising content further comprises:
causing changes to one or more channels within a group of multiple channels which are predominately composed of advertising content.

9. The method of claim 8, wherein causing changes to one or more channels within a group of multiple channels which are predominately composed of advertising content further comprises:
causing changes to one or more channels comprising one or more ad pools targeted to one or more subscriber characteristics.

10. The method of claim 9, wherein causing changes to one or more channels comprising one or more ad pools targeted to one or more subscriber characteristics further comprises:
causing changes to one or more ad pools targeted to characteristics of one or more subscribers associated with premise equipment receiving the program stream channel.

11. The method of claim 10, wherein causing changes to one or more ad pools targeted to characteristics of one or more subscribers associated with the premise equipment receiving the program stream channel further comprises:
causing changes to one or more ad pools targeted to one or more of subscription information, content viewing habits of the subscribers, characteristic of an area and/or region comprising subscriber premises, subscriber demographic information, subscriber financial and/or income and/or employment information, or subscriber Internet viewing habits.

12. The method of claim 9, wherein causing changes to one or more channels comprising one or more ad pools targeted to one or more subscriber characteristics further comprises:
network equipment selecting one or more ads of the ad pools that should be presented to the subscriber, and communicating channel information to the regional equipment for the one or more selected ads.

13. The method of claim 9, further comprising:
forming ad pools for a subscriber region at least in part according to characteristics of the region and/or subscribers therein.

14. The method of claim 9, further comprising:
embedding ad content of the ad pools in multiple program streams.

15. The method of claim 1, further comprising:
the regional equipment selecting which ad content to render from among multiple available ads on the other channels comprising advertising content.

16. The method of claim 1, further comprising:
causing one or more channel changes back to the program stream at the conclusion of one or more ad break durations.

17. The method of claim 1, further comprising:
the program stream comprising identifications of the one or more other channels comprising advertising content.

18. The method of claim 1, further comprising:
introducing one or more delays between the program content stream and one or more streams comprising the advertising content.

19. The method of claim 18, wherein introducing one or more delays between the program content stream and one or more streams comprising the advertising content further comprises:
the regional equipment buffering at least a portion of the advertising content.

20. The method of claim 18, wherein introducing one or more delays between the program content stream and one or more streams comprising the advertising content further comprises:
the regional equipment buffering at least a portion of the program content.

21. The method of claim 1, further comprising:
communicating ad break information for the program stream to the regional devices prior to, at, or near to a time or times when the program stream is delivered to the regional devices.

22. The method of claim 1, further comprising:
communicating ad break information for the program stream to one or more regional devices prior to, at, or near to a time or times when the advertising content is to be presented to one or more users of the regional devices.
